(19) United States
(12) Patent Application Publication
(10) Pub. No.: US 2017/0346909 A1
(43) Pub. Date: Nov. 30, 2017

(54) CLIENT-SIDE BOTTLENECK ANALYSIS USING REAL USER MONITORING DATA

(71) Applicant: LinkedIn Corporation, Mountain View, CA (US)

(72) Inventors: Ruixuan Hou, Sunnyvale, CA (US); David He, Cupertino, CA (US); Ritesh Maheshwari, Mountain View, CA (US); Swapnil Ghike, Sunnyvale, CA (US)

(21) Appl. No.: 15/169,210

(22) Filed: May 31, 2016

(51) Int. Cl. H04L 29/08; H04L 12/26; H04L 29/06

(52) U.S. Cl. CPC H04L 67/16; H04L 67/42; H04L 43/0876; H04L 67/02

(57) ABSTRACT

Techniques are provided for analyzing client-side performance data. In one technique, first client performance data and second client performance data is received. The first client performance data was generated by a first client device and indicates a first plurality of processing items that includes a first processing item that is associated with first item performance data. The second client performance data was generated by a second client device and indicates a second plurality of processing items that includes a second processing item that is associated with second item performance data. In response to determining that the first processing item is associated with the second processing item, an aggregate data value is computed based on the first item performance data and the second item performance data.

### CROSS REFERENCE TO RELATED CASES

This application is related to U.S. application Ser. No. 14/987,582, which was filed on Jan. 4, 2016 and is incorporated by reference as if fully described herein.

### FIELD OF THE DISCLOSURE

The present disclosure relates to analyzing client performance data from multiple client devices.

### BACKGROUND

Most application developers desire to develop applications that create and load pages relatively fast. However, current tools for testing and debugging web applications suffer from many drawbacks. One such drawback is that current tools are often connected to a fast network, whereas end-users accessing a deployed version of a web application may not be connected to a fast network and, thus, may experience slow loading times. Another drawback is that current tools allow developers to see only a single page view, which may be “noisy” and not be reflective of what many end-users will experience. Yet another drawback is that a network call that appears to be a bottleneck during page loading may not in fact be a bottleneck because the network call may be made in parallel with other network calls and, thus, is not slowing down the loading of a page.

### BRIEF DESCRIPTION OF THE DRAWINGS

In the drawings:

FIG. 1 is a block diagram that depicts a system 100 for generating and processing client performance data, in an embodiment;

FIG. 2A is a diagram of an example screenshot that depicts multiple processing items associated with a single CPD-initiating request from a web browser, in an embodiment;

FIG. 2B is a diagram of an example screenshot that depicts multiple processing items associated with a single CPD-initiating request from a native application, in an embodiment;

FIG. 3 is a flow diagram that depicts a process for determining a contribution of a processing item to overall page loading time or to certain times or phases within a page loading time, in an embodiment;

FIG. 4A is a diagram that depicts a table that includes aggregated client performance data from multiple client devices about multiple types of processing items, in an embodiment;

FIG. 4B is a diagram that depicts an example chart showing aggregated client performance data, in an embodiment;

FIG. 5 is a screenshot of an example interface provided by a CPD tool, in an embodiment;

FIG. 6 is a flow diagram that depicts a process for receiving and processing CPD from multiple client devices, in an embodiment;

FIG. 7 is a block diagram that illustrates an example computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for collecting and processing client performance data are described. Client devices generate client performance data that is based on retrieving content from a remote source, processing the content, and/or displaying the processed content at the client device. Client performance data indicates how long certain processes took to complete, such as establishing a connection and retrieving certain content items. The client devices send their respective client performance data to a central computing system that processes the client performance data in one or more ways, including displaying client performance data that originated from a single client device, classifying certain data or activities within client performance data, and aggregating client performance data from multiple client devices. The central computing system may also provide a tool that allows users, administrators, or application developers to view processed client performance data.

### System Overview

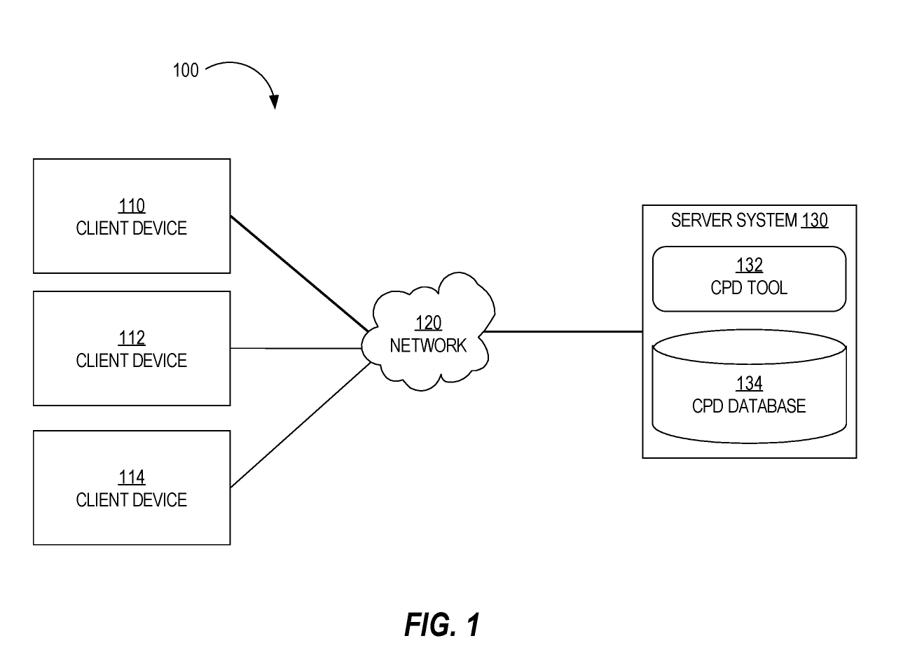

FIG. 1 is a block diagram that depicts a system 100 for generating and processing client performance data, in an embodiment. System 100 comprises client devices 110-114, network 120, and server system 130. While only three client devices are depicted, system 100 may include many client devices that are communicatively coupled to server system 130 over network 120.

Network 120 may be implemented on any medium or mechanism that provides for the exchange of data between client devices 110-114 and server system 130. Examples of network 120 include, without limitation, a network such as a Local Area Network (LAN), Wide Area Network (WAN), Ethernet or the Internet, or one or more terrestrial, satellite or wireless links.

Examples of client devices 110-114 include a laptop computer, a tablet computer, a desktop computer, and a smartphone. Each of client devices 110-114 may include many applications and capabilities that are unrelated to sending or retrieving content from server system 130, such as a contacts manager, a camera, digital games, a word processor, a flashlight, etc.

### Client Performance Data

Each of client devices 110-114 generates client performance data (CPD) and transmits CPD to server system 130. CPD indicates, for at least one client device, information about timing and/or data quantity of multiple processing items associated with the client device. A processing item may be an activity, a data item, or an event. Examples of activities include a DNS lookup, TCP connection setup, executing a script, processing content, content download time, rendering a page, and the making and completion of a network call, such as an AJAX call. Examples of data items include an image, advertisement, video, a CSS file, a subdocument, or an iframe. In some cases, a processing item refers to both an activity and a data item, such as a request for an image or a network call that results in a CSS file.

Examples of events include when certain elements are loaded, a Document Object Model (DOM) complete time, and a first byte time (or the time at which the first byte of data is received from server system 130). A DOM complete time may calculated by comparing the time when a CPD-initiating request was submitted and the time when a DOMContentLoaded event or DOMFrameContentLoaded event is generated. Alternatively, a DOM complete time may be calculated by comparing the time when the first byte of requested content is received and the time when a DOMContentLoaded event or DOMFrameContentLoaded event is generated. Each type of browser may generate a different set of DOM events. DOM events allow event-driven programming languages like JavaScript, Jscript, ECMAScript, VBScript, and Java to register various event handlers/listeners on the element nodes inside a DOM tree, e.g., HTML, XHTML, XUL, and SVG documents.

Different processing items are tracked separately. For example, a first request for an image may be tracked separately from a second request for an iframe even though both requests are made while processing the same content request (e.g., a HTTP request for a particular web page). Similarly, a first request for a first image may be tracked separately from a second request for a second image that is different than the first image even though both requests are made while processing the same content request.

Content requests from different client devices for the “same” page or content may result in receiving the same exact content or different content. For example, a content request may include user credentials, a cookie, or other user-related data that causes server system 130 to respond with a page or content that is tailored to the specific user that initiated the content request. For example, a first request from a first user for a profile page may result in a first profile page that includes profile information about the first user while a second request from a second user for a profile page may result in a second profile page that includes profile information about the second user. Thus, while some of the content in the first and second profile pages may be the same, some of the content will be different.

Some processing items may only be associated with time data while some processing items may be associated with both time data and size data that indicates an amount of data (e.g., in KB or bytes) that is involved in the processing item. For example, a DNS request might only be associated with time data (e.g., 5 ms or timestamp A and timestamp B) while a request for an image may be associated with an amount of time that elapsed while waiting to completely download the image and the size of the image itself.

Some processing items may be associated with computing systems other than server system 130, such as third-party content providers. For example, while some content may be retrieved from server system 130, other content (e.g., images and iframes) may be retrieved from one or more ad servers or other content providers. As another example, some content may be retrieved from one or more content delivery networks (CDNs) that are associated with the computing system to which the CPD-initiating request is directed.

A single instance of CPD is generated at a client device (e.g., client device 110) in response to a request that is submitted to server system 130 (or another computer system, not depicted). The request is referred to as herein as a “CPD-initiating request.” The request is a request for content from, for example, server system 130. The request may be HTTP request that includes a URL, such as a home page, another public page, or a private page hosted by server system 130. The request may or may not include user credentials. The request may be sent in response to user input, such as entering a URL in a text field of a web browser, selecting a graphical button, or opening a client (or “native”) application (e.g., a smartphone app) that is configured to communicate with server system 130.

A CPD-initiating request results in multiple client side activities (which are examples of processing items), such as additional requests, calls, executions (e.g., of scripts), downloading, processing, rendering, displaying, and even waiting. For example, a CPD-initiating request may result in a DNS request, establishing a TCP connection, a request for content, downloading the content (or at least a portion thereof), executable multiple scripts found in the content, retrieving multiple iframes (e.g., to different domains than the domain of the CPD-initiating request) referenced in the content, retrieving multiple images referenced in the content, assembling (or processing) downloaded content, and rendering the assembled content on a screen of the client device. Each of these activities may be tracked separately from the other activities.

### Server System

Although depicted as a single element, server system 130 may comprise multiple computing elements and devices, connected in a local network or distributed regionally or globally across many networks, such as the Internet. Thus, server system 130 may comprise multiple computing elements other than client performance data (CPD) tool 132 and CPD database 134.

CPD database 134 stores multiple instances of CPD that server system 130 receives from client devices 110-114. A component of server system 130 may process (e.g., modify) a portion of CPD from a client device prior to storing the CPD in CPD database 134. CPD database 134 may be stored on one or more storage devices (persistent and/or volatile) that may reside within the same local network as server system 130 and/or in a network that is remote relative to server system. Thus, although depicted as being included in server system 130, each storage device may be either (a) part of server system 130 or (b) accessed by server system 130 over a local network, a wide area network, or the Internet.

CPD tool 132 retrieves CPD from CPD database 134, analyzes the CPD, and causes data resulting from the analysis to be displayed on one or more computing devices, such as a computing device that is similar to one of client devices 110-114. CPD tool 132 may be implemented in hardware, software, or any combination of hardware and software. Although depicted as a single element, CPD tool 132 may also comprise multiple elements and devices. CPD tool 132 may be a web-based tool or may work with a native application (executing on a client device) that is configured to communicate with CPD tool 132 over network 120.

In an embodiment, server system 130 stores or has access to information about multiple accounts, each corresponding to a different entity, such as an individual user, group of users, or organization (e.g., a business, government entity, etc.).

### Instance of Client Performance Data

A single instance of client performance data (CPD) is associated with a single client device. A single instance of CPD includes data about one or more CPD-initiating requests submitted by the client device. If a single instance of CPD includes data about multiple CPD-initiating requests, then the client device aggregates or combines information about the multiple requests.

A single instance of CPD indicates one or more characteristics of the corresponding client device, a user of the client device, and/or the CPD itself. Example characteristics of a client device include a type of device (e.g., tablet, smartphone, desktop), a type of operating system (e.g., iOS, Android), a version of the operating system, a web browser that was used (if used) to request content from a remote server, a native (or client) application that was used (if used) to request content from a remote server. Characteristics of a user of a client device may include a current employer, a job status, academic history (e.g., degrees earned), employment history, skills, endorsements, demographic information, or anything that may be included in a profile of the user. A profile of the user may be maintained by server system 130, which may host a social network service, such as Linkedln, Facebook, and Google+. An example of a characteristic of the CPD itself includes a time when the CPD was created or when a request that resulted in the CPD being created (referred to herein as a CPD-initiating request) was sent. Another example is a geographic location of when the CPD is created.

If a single instance of CPD includes data about multiple requests, then the client device aggregates or combines information about the multiple requests, but may maintain individual time and/or geographic information associated with each request. Thus, a single instance of CPD may indicate multiple dates and times and multiple geographic regions/locations.

### Generating Client Performance Data

While CPD is generated at a client device, how the CPD is generated may differ depending on whether the entity sending the initial request to server system 130 is a web browser (e.g., Chrome, Firefox) or a native application that is developed and/or distributed by the entity responsible for the content/services provided by server system 130. If a native application, then the native application includes code that generates time data that indicates when each activity commences and/or concludes and, optionally, a duration of the activity. The code may also determine the size of each content item (e.g., image, iframe, CSS file) downloaded from server system 130. Thus, time data may include multiple timing data items, such as a start time and a duration or a start time and an end time. Server system 130 (or another computer system) may derive the duration if only a start time and end time of an activity is included in an instance of CPD. The preciseness of each timestamp may be in seconds, deciseconds, centiseconds, milliseconds, microseconds, or any other time-based unit. (A timestamp may be an absolute time or a relative time.) The native application may send the time data immediately when all processing associated with the CPD-initiating request ceases or later “in the background”, such as when computing resources are level heavily used or when network bandwidth increases.

In the case where a client device sends a CPD-initiating request, the client device may include a plug-in (e.g., one that works for Web, Android, or iOS applications) that generates and stores time data indicating when the above-mentioned activities begin and end. Additionally or alternatively, requested content from server system 130 may include code that, when executed, generates time data and, optionally, size data regarding the size of data items that are retrieved from one or more remote sources. Such code may be some of the first code that is downloaded from server system 130 so that as much performance data about the subsequent client performance can be generated. Again, the client device may send

### Client-Side Call Tree

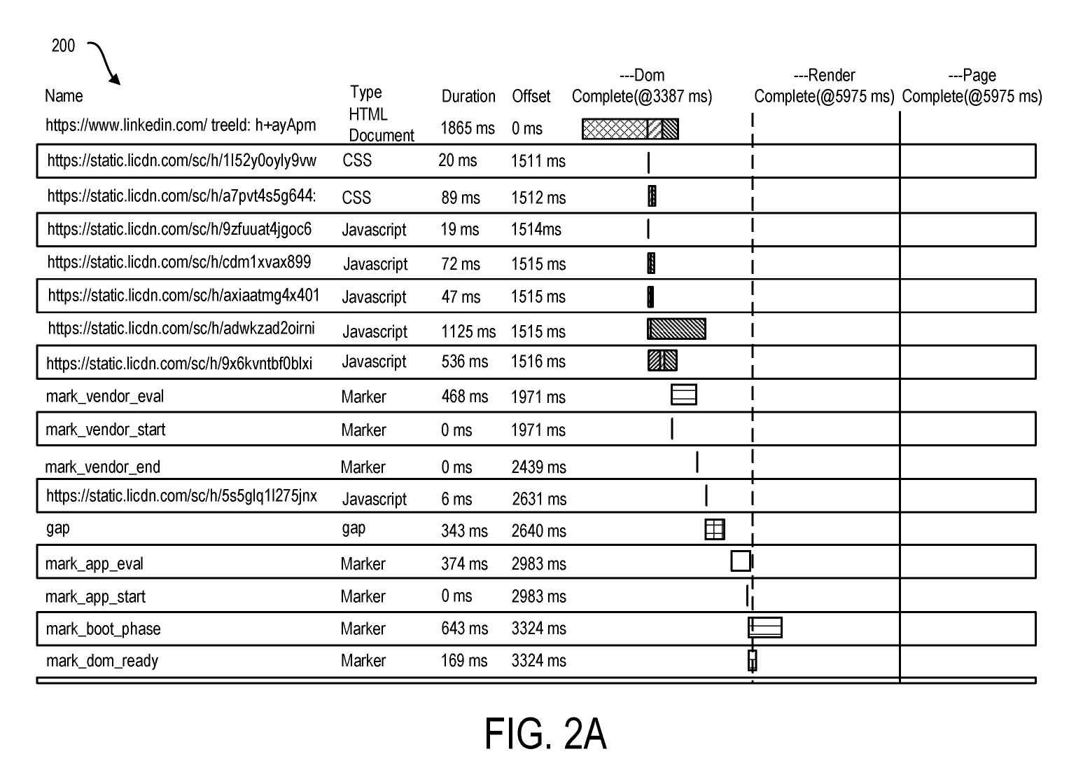

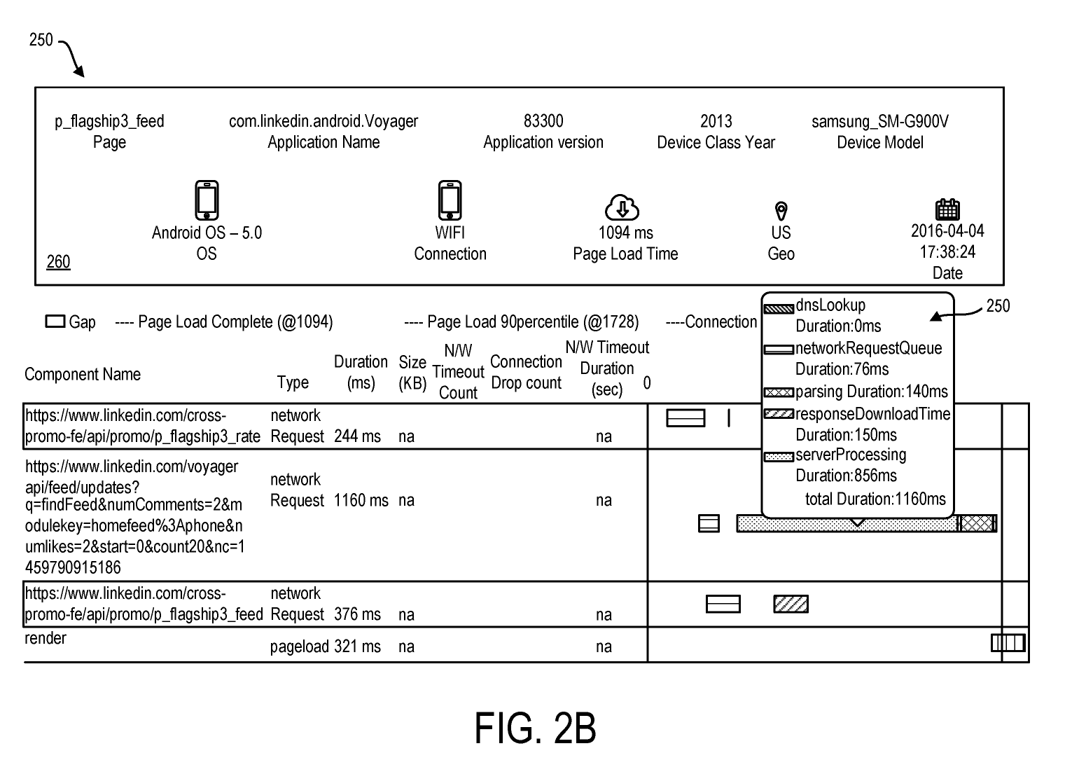

FIG. 2A is a diagram of an example screenshot 200 that depicts multiple processing items associated with a single CPD-initiating request from a web browser, in an embodiment. The display depicted in screenshot 200 may be generated by CPD tool 132 that reads data from CPD database 134. Screenshot 200 includes four columns of information: name of processing item, type of processing item, duration (in milliseconds), and offset (in milliseconds). Duration refers to an amount of time to begin processing a processing item (e.g., requesting and receiving a CSS file from a remote source).

Screenshot 200 also indicates when the following phases of a web page loading process complete: the DOM phase, the render phase, and the page phase. In many instances, the end of the page phase is after the render phase has completed and once all images are loaded. For some pages, images might finish loading before rendering has complete. In that case, the render complete time would be the same as the page complete time. Also, “DOM ready” (marking the end of the DOM phase) is a built-in browser event for traditional pages and single page applications. Render complete is similar in concept to DOM ready but is only for single page applications, such as Ember applications.

The types of processing items in this example include HTML document, CSS file, JavaScript, a marker, and a gap. A “marker” is used to measure customized events that are not pure network calls, such as critical code JavaScript execution time, some portions of UI rendering time. A “gap” refers to a period of time when no processing items are “active,” or when no data is being requested or when no data is being waited for. In this example, there are six JavaScript scripts that are referenced and executed. As screenshot 200 indicates, some JavaScript scripts take longer to process than others.

FIG. 2B is a diagram of an example screenshot 250 that depicts multiple processing items associated with a single CPD-initiating request submitted from a native application, in an embodiment. The display depicted in screenshot 250 may be generated by CPD tool 132 that reads data from CPD database 134. Screenshot 250 includes section 260 that includes information about the characteristics of the client device, application involved, and other high-level information. Specifically, section 260 indicates a specific page that was received (“p_flagship3_feed”), a name of an application that was used (“com.linkedin.android.Voyager”) to submit a CPD-initiating request, a version number of the application (“83300”), a class year of the device that executed the application (“2013”), a device model (“samsung SM-G900V”), an operating system (“Android OS—5.0”), a type of connection (“WIFI”), a total page load time (“1094 ms”), a geographic region where the CPD-initiating request originated (“US”), and a date and time at which the CPD-initiating request was submitted or completely processed (“2016-04-04 17:38:24”). Although not depicted in screenshot 200, some of this information (e.g., browser type and version) may be presented on that display as well.

Screenshot 250 also indicates (1) names of processing items or components, (2) types of processing items, (3) duration (in milliseconds) of each processing item, (4) size of data associated with the processing item, (5) whether a network timeout occurred, (6) whether a connection was dropped, and (7) a duration of any network timeout duration. Screenshot 250 also includes an information box 270 that includes a color legend and indicates information about processing items involved in the CPD-initiating request, such as the duration of the DNS lookup (which was 0 ms in this example), the duration of a network request queue, the duration of parsing (which was 140 ms in this example), the duration of downloading the response (which was 150 ms in this example), and the duration of server processing (which was 856 ms in this example). Regarding the network request queue, due to limitations of some network resources, some network requests wait in a queue before other requests finish and release the network resource. Information box 270 may be displayed in response to user selection of one of the duration bars associated with the second processing item or a scroll-over of that duration bar.

The displays in screenshots 200 and 250 allow application developers to see which processing items are taking the most time (at least with respect to the performance of a single client device) and, as a result, determine which processing items should be the focus of optimizing.

### Classifying Processing Items

In an embodiment, multiple processing items are classified into types of processing items. For example, a CPD-initiating request causes five different AJAX calls to be made. Thus, the CPD for that request may indicate five different (e.g., timing) measurements, one for each of the five AJAX calls. Each measurement is associated with the same type of processing item, which association is used to associate the five measurements together. The five measurements may be later aggregated or combined (based on the common processing type) to create a single measurement. The client device may perform that aggregation or server system 130 may perform the aggregation.

FIG. 2A indicates an example of classifying processing items, including two different CSS files that are requested and downloaded from a content delivery network associated with the target entity that processes the initial request for an HTML document. Based on this classification, CPD tool 132 may calculate a total, average, median, percentile, or other aggregate value based on the multiple time durations. In this example, although not depicted in FIG. 2A, the average duration for downloading CSS files is 54.5 milliseconds. In an embodiment, a display similarly depicted in screenshot 200, aggregated data about each of multiple types of processing items may be included in the display.

### Parallelism

In some instances, multiple processing items may occur in parallel. For example, multiple requests for iframes may be submitted concurrently to one or more remote servers. As another example, multiple scripts may be executed in parallel. Such concurrency or parallelism is a positive feature for client performance. Thus, the more parallelism, the better.

In an embodiment, processing items that do not exhibit any parallelism (“non-parallel items”) are treated or scored differently than processing items that do exhibit parallelism (“parallel items”). For example, if a set of parallel items occur in parallel with respect to each other, then the performance data associated with each processing item in the set is reduced. As a specific example, if two processing items occur in parallel for 10 ms, then 5 ms of that 10 ms is attributed to one processing and the other 5 ms is attributed to the other processing. As another specific example, if three processing items occur in parallel for 12 ms, then 4 ms is attributed to each of the three processing items.

In many cases, parallel items do not overlap perfectly in time. For example, a first processing item may only be operating (or “active”) during the “pendency” of a second processing item (i.e., the first processing item begins after the second processing item begins and ends before the second processing item ends). In this example, the portion of time that the second processing item does not overlap with the first processing item may be treated normally.

Parallelism may be detected by comparing the start times and end times associated with multiple processing items. If one processing item has an end time that is before the start time of another processing item, then the two processing items are not parallel items. If a first processing item has a start time that is before the end time of a second processing item and the first processing item has an end time that is after the start time of the second processing item, then the two processing items are parallel items.

### Per-Processing Item Contribution

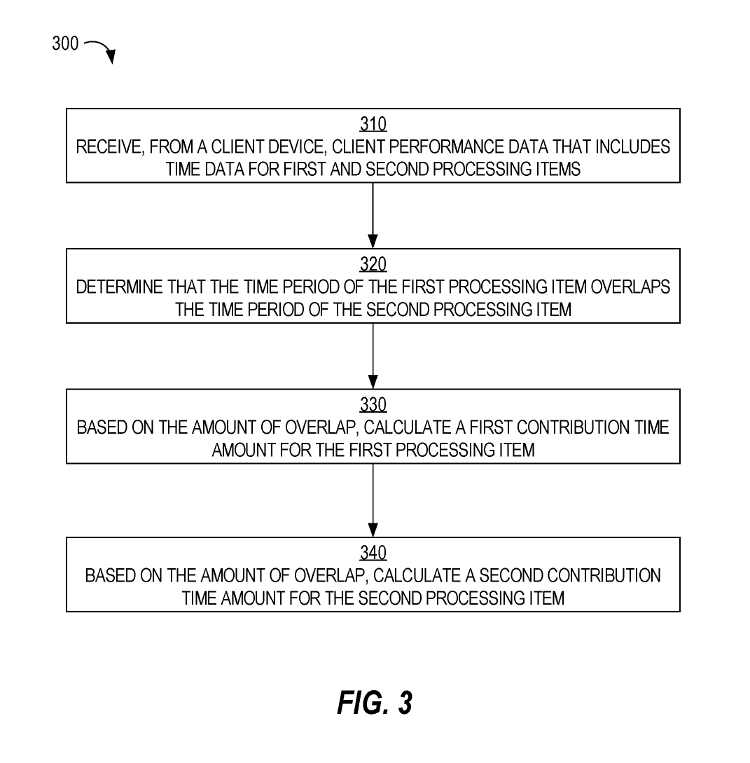

FIG. 3 is a flow diagram that depicts a process 300 for determining a contribution of a processing item to overall page loading time or to certain times or phases within a page loading time, in an embodiment.

At block 310, client performance data is received from a client device. The client performance data includes time data for each of multiple processing items. The time data for each processing item may include a starting timestamp, an ending timestamp, and/or a duration.

At block 320, it is determined that the time period of the first processing item overlaps the time period of the second processing item. Block 330 may involve determining whether the starting timestamp of the first processing item is between the starting and ending timestamps of the second processing item or the ending timestamp of the first processing item is between the starting and ending timestamps of the second processing item.

At block 330, based on an amount of time that the two time periods overlap (or “overlap time”), a first contribution time amount is calculated for the first processing item. If the time period of the first processing item (or “first time period”) is entirely within the time period of the second processing item (or “second time period”), then the first contribution time amount may be determined to be less than the first time period. For example, the first contribution time amount may be calculated by dividing the first time period by two (or more if the first time period is also within the time period of a third processing item).

Block 330 may also involve taking into account (for the first contribution time amount) a portion of the first time period that does not overlap with the second time period (or a time period of any other processing item). For example, if the first period of time is 10 ms and the overlap time is 4 ms, then the first contribution time amount may be (4 ms/2 ms)+(10 ms-4 ms)=8 ms.

At block 340, based on the overlap time, a second contribution time amount is calculated for the second processing item, which calculation may be similar to the calculation in block 330.

### Aggregating Client Performance Data from Multiple Client Devices

In an embodiment, CPD from multiple client devices is aggregated or combined based on one or more criteria. Example criteria include any type of information found in the CPD, such as one or more device characteristics (e.g., OS type or browser version), one or more user characteristics (e.g., job status, skills), and/or one or more CPD characteristics (e.g., date/time, geographic region).

Thus, for example, an application developer may be able to view how client devices located in China and running a particular version of a web browser performed when retrieving content related to a particular web page. Thus, the type of browser and the geographic location of client devices may have a significant impact on device performance. For example, all else being equal (e.g., requested content, type of browser, type of OS, etc.), client devices in China may be perform differently than client devices in India. Also, client devices may perform differently depending on which content is requested. For example, client devices may download and process content associated with a profile page much slower than client devices that download and process content associated with a search page. Administrators may inform developers of the profile page that they should focus on improving download times and, optionally, which specific processing items should receive attention.

Server system 130 (or another system affiliated with server system 130) performs the aggregation. The aggregation may be performed prior to any user or administrator requests. For example, there may be default aggregations that are previously defined by a user. As another example, such aggregations may be “learned” by tracking which aggregations have been performed previously (in response to user input) and/or most often. Additionally or alternatively, at least some aggregations are performed in response to a user or administrator request. For example, CPD tool 132 provides a user interface that displays client performance data and that allows a user of the tool to select one or more criteria for aggregating CPD from multiple client devices.

Multiple processing items (e.g., downloading a particular CSS file) may be aggregated in one or more ways. Example aggregations include calculating an average, determining a median or another percentile, determining a minimum value, and determining a maximum value. For example, an average time to process content retrieved from a remote source is calculated and recorded and an average time to render the processed content on a display of a computer device is calculated and recorded. As another example, a median time to download a first image is determined and recorded and a median time to download a second image (that is requested as a result of the same CPD-initiating request as the first image) is determined and recorded.

### Blocking Calls

In an embodiment, blocking calls are detected in client performance data. A “blocking call” is a processing item where no other processing item overlaps it in time. Thus, a “blocking call” is a call, request, or other activity that at least appears to block other processing items from occurring. A blocking call may be specific to a particular processing item, rather than to all processing items of the same type. For example, a first request for a first CSS file might be a blocking call while a second request for a second CSS file (that is different than the first CSS file) might not be a blocking call.

A blocking call may be detected by the client device that generated the CPD (e.g., by a native application that requested content from server system 130) or by CPD tool 132.

A blocking call detected in one instance of CPD may not be a blocking call in another instance of CPD. Thus, the first blocking call may be a false positive with respect to the corresponding CPD instance.

In an embodiment, CPD tool 132 analyzes CPD from multiple client devices to identify one or more blocking calls. Thus, none of the blocking calls may be a non-blocking call in any of the CPD that CPD tool 132 analyzes to identify the one or more blocking calls. With this information, an application developer can identify areas where a web (or native) application can improve by, for example, replacing a blocking call with a non-blocking call or removing one or more blocking calls altogether.

### Gaps

In an embodiment, gaps are detected in client performance data. As described previously, a “gap” is a period of time when no processing items are “active,” or when no data is being requested or when no data is being waited for. A gap in client performance data may be detected by the client device that generated the CPD (e.g., by a native application that requested content from server system 130) or by CPD tool 132.

A gap may be identified by ordering all processing items by start time and, then, for each processing item beginning with the earliest processing item, identify the end time and determine whether any other subsequent processing item is pending at the end time. If not, then a gap is detected. Otherwise, a pending processing item is selected, its end time is identified, and it is determined whether any other subsequent processing item is pending at that end time.

In an embodiment, for each gap, it is determined what (1) the last pending processing item was when the gap begins and (2) the first processing item that began when the gap ends. Such information may be useful for application developers to know which processing items may be causing the gap. Gap information may be aggregated across multiple instances of CPD to identify which processing items appear the most in the gap data. In a related embodiment, gap information may be aggregated based on the same exact processing item (e.g., execution of a specific script) and/or based on the same type of processing item (e.g., execution of any script). If the former, then such aggregated data may reveal that (1) some processing items of a particular type are causing (or are otherwise associated with) the gaps and (2) other processing items of the particular type are not causing the gaps.

### Displaying Aggregated Client Performance Data

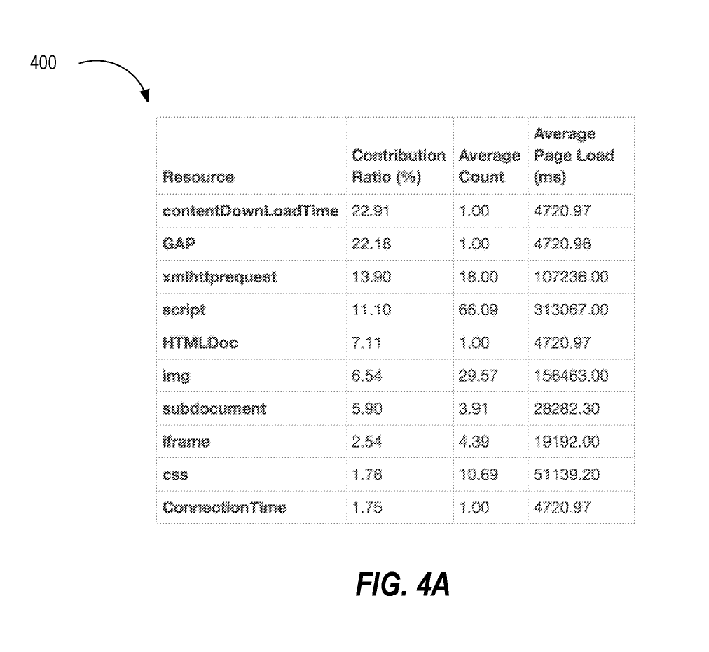

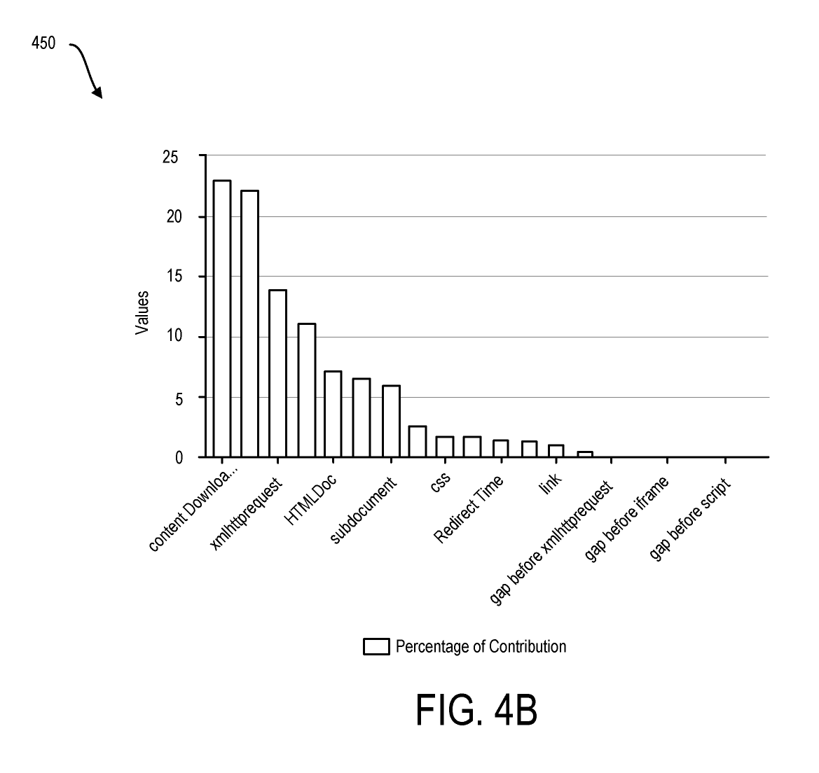

FIG. 4A is a diagram that depicts a table 400 that includes aggregated client performance data from multiple client devices about multiple types of processing items or “resources,” in an embodiment. The client performance data reflected in table 400 may be limited to a single requested content (e.g., a particular web page) or may be based on different requested content (e.g., a profile page, a search page, and a home page). The first column indicates a name for each type of processing item (or “resource type”), the second column indicates a contribution ratio for each resource type, the third column indicates an average count of each resource type, and the fourth column indicates an average load time of each resource type.

The performance data for a particular resource type may correspond to multiple resources of that particular resource type. For example, table 400 indicates that an average of 18 AJAX calls are made for each CPD-initiating request. As another example, table 400 indicates that an average of 29.57 images are requested for each CPD-initiating request.

FIG. 4B is a diagram that depicts an example chart 450 showing aggregated client performance data, in an embodiment. The x-axis of chart 450 lists each resource type and the y-axis shows contribution ratio. In the depicted example, the resource types are listed based on contribution ratio in descending order. Alternatively, the resource types may be listed based on contribution ratio in ascending order, alphabetically, or in any other manner.

### Connection Time

In an embodiment, connection time is tracked and reflects an amount of time that elapses before a client device (e.g., client device 110) establishes a connection with server system 130. Connection time begins when the client device submits a CPD-initiating request to server system 130. Connection time may be considered a proxy for one or more network resources. A single connection time may be based on multiple processing items and their associated times, such as an amount of time to resolve a domain name using a domain name server (DNS) and an amount of time to establish a Transport Control Protocol (TCP) connection with server system 130. Thus, even though connection time is depicted as a single resource type and has a count of 1 in table 400, the connection time may be composed of multiple times.

In an embodiment, a user that views table 400 or chart 450 is allowed to select connection time, causing details about the individual times (upon which the connection time metric is based) to be displayed, such as a DNS time and a TCP connection time. Aggregated CPD from client devices located in certain geographic regions may reveal that those geographic regions are associated with relatively slow DNS times and/or slow TCP times. Such details may allow the entity that owns or manages server system 130 to take steps to improve such connection times rather than spending time and resources on attempting to increase parallelism or otherwise improve content download times.

### CPD Tool Interface

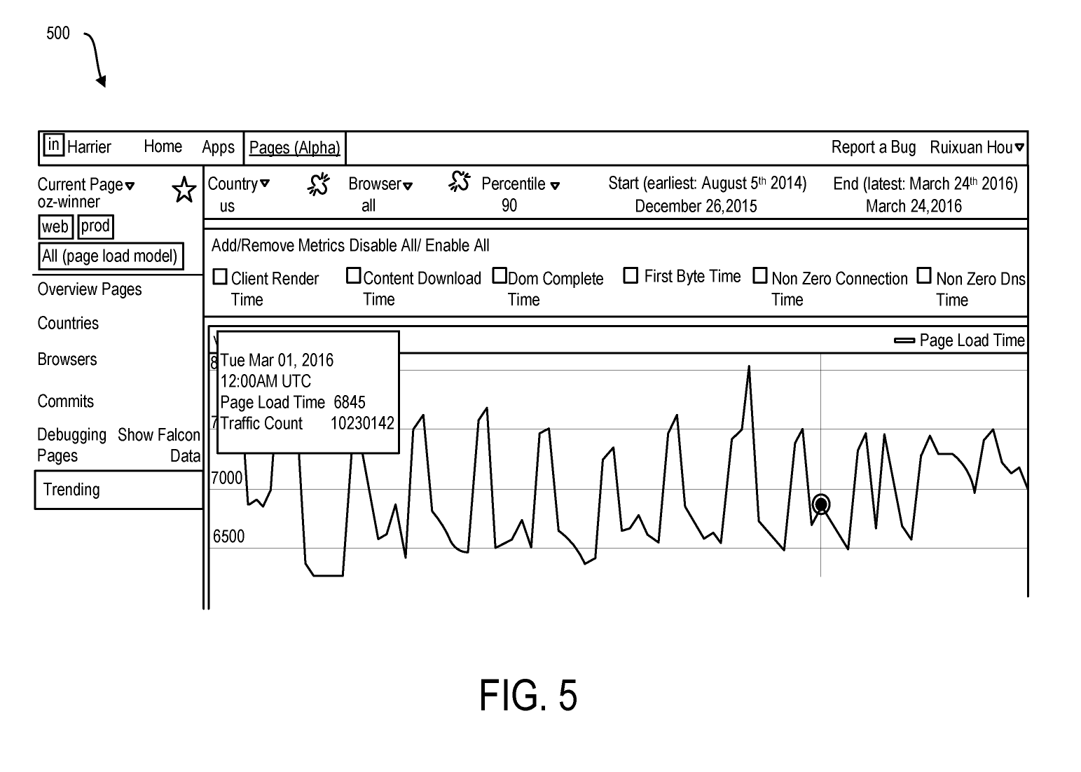

FIG. 5 is a screenshot of an example interface 500 provided by CPD tool 132, in an embodiment. Interface 500 allows a user to select multiple aggregation criteria, thus allowing the user to request different views of a set of aggregated CPD across multiple dimensions. The aggregation criteria in this depicted example include metric, geographic location (or country), browser type, percentile, and date range. In response to receiving user input, CPD tool 132 performs one or more actions, such as aggregating CPD from multiple client devices, including that different processing items associated with different client devices are to be aggregated.

In this example, a user can select one of many different client-side metrics, such as client render time, page load time, content download time, DOM complete time, first byte time, non-zero connection time, and non-zero DNS time. Metrics that are not displayed in interface 400 may include individual gap times, total gap times per CPD-initiating request, and any other type of processing item or specific processing item, such as JavaScript execution times, per-image download times, or a specific CSS file download time.

Interface 500 allows a user to select a different time range. In this example, the time range is Dec. 26, 2015 to Mar. 24, 2016, which may be a default time range. Interface 500 also indicates what start dates and end dates are possible.

Interface 500 allows a user to select a country or geographic region to allow the user to see how client devices in the selected country or geographic region are performing. Example geographic regions include continent specifications (e.g., Asia, North America, etc.), region specifications (e.g., Eastern Europe, Southeast Asia), or other designation that corresponds to a contiguous or non-contiguous region (e.g., Portuguese-speaking countries). In the depicted example, CPD from only the United States is considered when generating the depicted graph.

Interface 500 also allows a user to select a type of browser, examples of which may include Chrome, Firefox, Internet Explorer, Safari, and a native application. The types of browsers may also include different versions of each browser type, such as versions 21 and 22 of Chrome. In the depicted example, CDP pertaining to all browsers is considered when generating the depicted graph.

Interface 500 also allows a user to select a different aggregation operation from among multiple types of aggregation operations, examples of which include average, median, maximum, minimum, or a specific percentile. In the depicted example, the 90^{th} percentile is selected.

Interface 500 displays a graph of the selected metric subject to the other selected criteria pertaining to time, country, browser type, and aggregation. In the depicted example, a graph of 90^{th} percentile page load times of client devices in the US on each day from Dec. 26, 2015 to Mar. 24, 2016 is created and displayed.

Also in the depicted example, a user provided input that corresponds to a specific day between the selected time range (i.e., Mar. 1, 2016). In response to receiving the input, CPD tool 132 displays an information box 510 that indicates a page load time of 6,845 ms and a traffic count (or number of CPD-initiating requests) of 10,230,142 that were received or processed on Mar. 1, 2016.

The CPD data reflected in the depicted graph pertain to a specific page, Alpha. Interface 500 allows a user to select another page that client devices can request, whether through a third-party browser or through a native application. Thus, if a user selects another page, then interface 500 would be updated and a different graph may be displayed. The settings in the updated interface might be the same as in interface 500 when the other page is selected, such as the page load time metric, US as the country, all browsers, 90^{th} percentile, and time range of Dec. 26, 2015 to Mar. 24, 2016. However, the graph may be very different since different pages may receive much different traffic, have different sized page loads, and be associated with a different number and types of processing items, each of which might have a large effect on page load time and the other metrics.

### Example Process

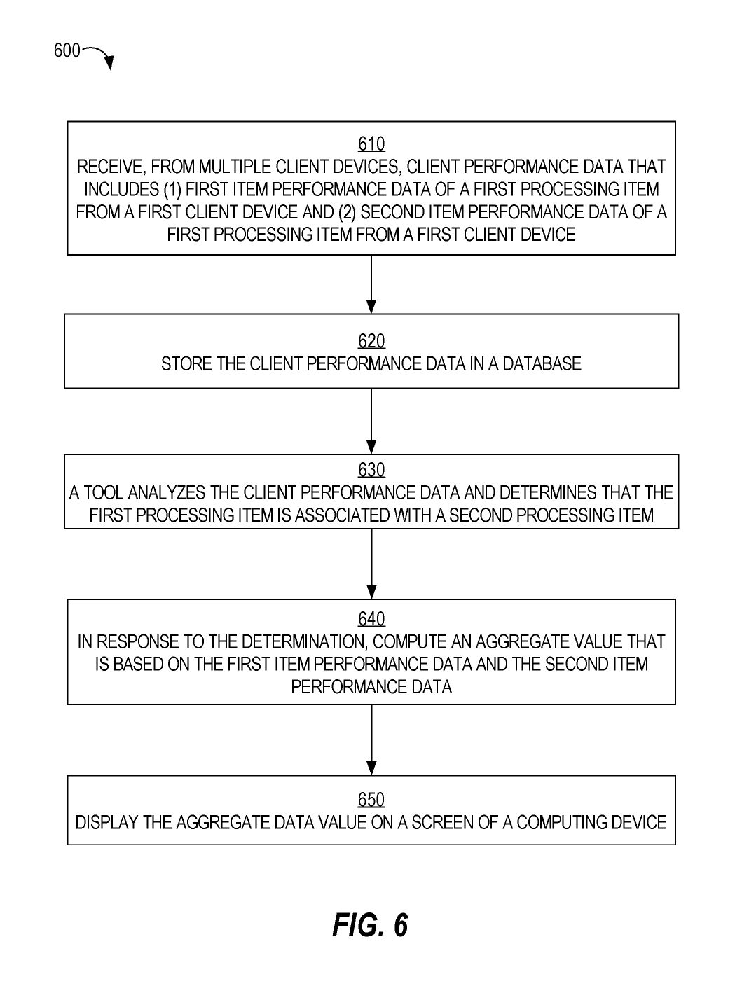

FIG. 6 is a flow diagram that depicts a process 600 for receiving and processing CPD from multiple client devices, in an embodiment. Process 600 may be at least partially implemented by server system 130 and, optionally, partially by a computing device of an administrator or developer affiliated with server system 130.

At block 610, CPD is received from multiple client devices over a network. The CPD includes first CPD that was generated by a first client device and that indicates multiple processing items that includes a first processing item that is associated with first item performance data. The CPD includes second CPD that was generated by a second client device and that indicates multiple processing items that includes a second processing item that is associated with second item performance data.

At block 620, the CPD is stored in CPD database 134.

At block 630, CPD tool 132 analyzes the CPD and determines that the first processing item is associated with the second processing item. This determination may be made by determining that the second processing item and the first processing item involve downloading or processing the same data item (such as a file or image) or are processing items of the same type, such as both involving downloading a certain type of data item or both involving rendering processed data on a screen.

Prior to block 630, process 300 may involve receiving user input (through a computing device that is separate from server system 130) that specifies a particular metric, such as which processing item or type of processing item to analyze. A default setting may involve analyzing all types of processing items. A user may then specify that a subset of processing item types or a subset of specific processing items is to be analyzed.

At block 640, in response to the determination that the first processing item is associated with the second processing item, an aggregate data value is computed based on the first item performance data and the second item performance data. Both item performance data may involve a time duration or a size of data item. The computation may involve an average. If block 640 involves determining that more than two processing items are associated with each other, then the computation may determining a median, a maximum, a minimum, or a certain percentile. Prior to block 640, process 600 may also involve receiving user input (through a computing device that is separate from server system 130) that specifies one of these types of computations.

At block 650, the aggregate data value is displayed on a screen of a computing device. Block 650 may be performed immediately after block 640. Alternatively, block 650 may first involve storing the aggregate data value. Later, user input is received (e.g., opening or activating CPD tool 132) that causes the aggregate data value to be displayed.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

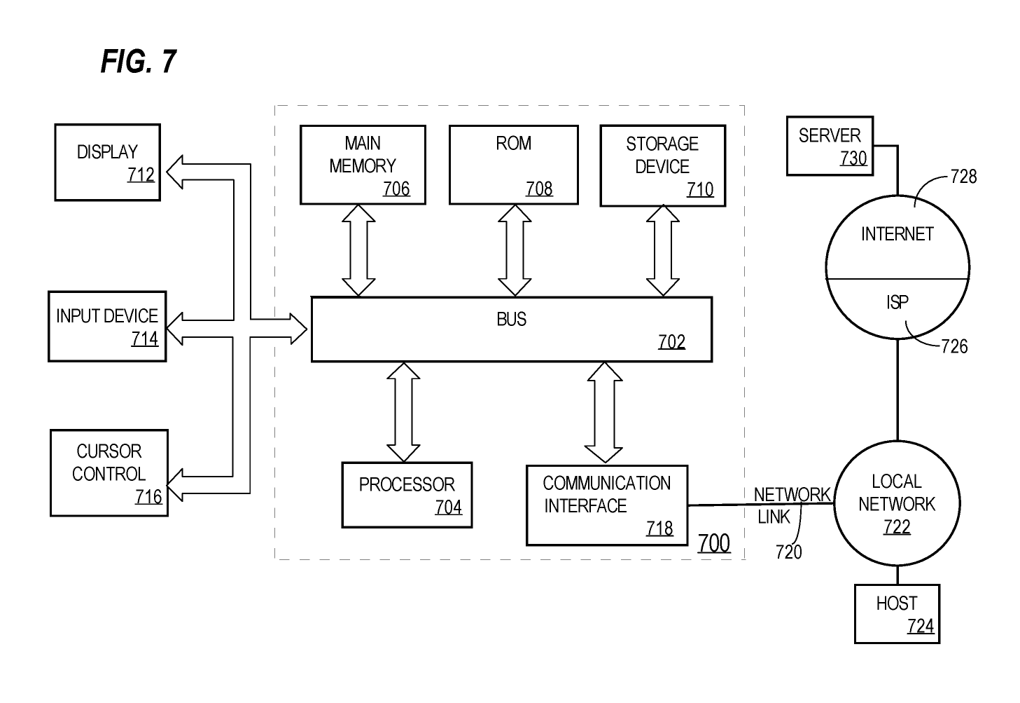

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a liquid crystal display (LCD), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving first client performance data that indicates a first plurality of processing items that includes a first processing item that is associated with first item performance data;
wherein the first client performance data was generated by a first client device based on an interaction between the first client device and a server system;
receiving second client performance data that indicates a second plurality of processing items that includes a second processing item that is associated with second item performance data;
wherein the second client performance data was generated, by a second client device that is different than the first client device, based on an interaction between the second client device and the server system;
in response to determining that the first processing item is associated with the second processing item, computing an aggregate data value based on the first item performance data and the second item performance data;
causing the aggregate data value to be displayed on a screen of a computing device;
wherein the method is performed by one or more computing devices.

2. The method of claim 1, wherein the first processing item and the second processing item are associated with the same particular data item.

3. The method of claim 2, wherein the first processing item and the second processing item are activities that involve processing or downloading the particular data item.

4. The method of claim 1, wherein:
the first processing item is associated with a first data item that is of a first type of data item;
the second processing item is associated with a second data item that is of the first type of data item.

5. The method of claim 1, wherein the first processing item is one of a DNS lookup, a TCP connection setup, an executable script, an AJAX call, an image, an advertisement, a video, a CSS file, a subdocument, or an iframe.

6. The method of claim 1, further comprising:
receiving input that specifies a metric from a plurality of metrics;
in response to receiving the input:
generating a graph that includes a first axis that corresponds to time and a second axis that corresponds to the metric,
generating a line that is based on the aggregate data value, and
displaying the line on the graph.

7. The method of claim 1, further comprising:
receiving input that specifies one or more aggregation criteria;
in response to receiving the input that specifies the one or more aggregation criteria, determining that the first processing item is associated with the second processing item.

8. The method of claim 7, wherein the one or more aggregation criteria includes one or more of a specific geographic region, an indication of one or more types of browsers, a specific time range, or a specific percentile or mean.

9. The method of claim 1, wherein:
the first client device generated the first client performance data as a result of requesting a particular page;
the second client device generated the second client performance data as a result of requesting the particular page.

10. The method of claim 9, wherein:
the first client device rendered a first page based on the particular page;
the second client device rendered a second page based on the particular page;
a first subset of the first page is the same as a first subset of the second page;
a second subset of the first page is different than a second subset of the second page.

11. The method of claim 10, wherein the second subset of the first page includes information about a first user and the second subset of the second subset of the second page includes information about a second user that is different than the first user.

12. The method of claim 1, further comprising:
storing, in association with the first client performance data, data that indicates whether the first client performance data was generated by a native application executing on the first client device.

13. The method of claim 1, wherein:
the first plurality of processing items includes a third processing item that is associated with third item performance data;
each processing item in the first plurality of processing items is associated with type data that indicates a type of said each processing item;
the method further comprising:
determining a first duration of the first processing item that is of a first type of processing item;
determining a second duration of the third processing item that is different than the first processing item but is of the first type of processing item;
based on the first processing item and the third processing item being of the first type of processing item, performing an aggregation operation that takes, as input, the first duration and the second duration.

14. A method comprising:
receiving, from a client device, timestamp data that indicates time data for each processing item of a plurality of processing items that are associated with a particular request that was initiated by the client device;
identifying first time data of a first processing item in the plurality of processing items, wherein the first time data indicates a first period of time;
identifying second time data of a second processing item in the plurality of processing items, wherein the second time data indicates a second period of time;
determining, based on first time data and the second time data, an amount of time that the first period of time overlaps the second period of time;
based on the amount of time that the first period of time overlaps the second period of time:
calculating a first contribution amount of the first processing item;
calculating a second contribution amount of the second processing item;
wherein the method is performed by one or more computing devices.

15. A system comprising:
one or more processors;
one or more storage media storing instructions which, when executed by the one or more processors, cause:
receiving first client performance data that indicates a first plurality of processing items that includes a first processing item that is associated with first item performance data;
wherein the first client performance data was generated by a first client device based on an interaction between the first client device and a server system;
receiving second client performance data that indicates a second plurality of processing items that includes a second processing item that is associated with second item performance data;
wherein the second client performance data was generated, by a second client device that is different than the first client device, based on an interaction between the second client device and the server system;
in response to determining that the first processing item is associated with the second processing item, computing an aggregate data value based on the first item performance data and the second item performance data;
causing the aggregate data value to be displayed on a screen of a computing device.

16. The system of claim 15, wherein the first processing item and the second processing item are associated with the same particular data item.

17. The system of claim 16, wherein the first processing item and the second processing item are activities that involve processing or downloading the particular data item.

18. The system of claim 15, wherein:
the first processing item is associated with a first data item that is of a first type of data item;
the second processing item is associated with a second data item that is of the first type of data item.

19. The system of claim 15, wherein the first processing item is one of a DNS lookup, a TCP connection setup, an executable script, an AJAX call, an image, an advertisement, a video, a CSS file, a subdocument, or an iframe.

20. The system of claim 15, wherein the instructions, when executed by the one or more processors, further cause:
receiving input that specifies a metric from a plurality of metrics;
in response to receiving the input:
generating a graph that includes a first axis that corresponds to time and a second axis that corresponds to the metric,
generating a line that is based on the aggregate data value, and
displaying the line on the graph.
